(19) United States
(12) Patent Application Publication
(10) Pub. No.: US 2009/0306294 A1
(43) Pub. Date: Dec. 10, 2009

(54) Method of producing comb block-copolymers from epoxy-functionalized nitroxylethers and anionically polymerizable monomers

(76) Inventors: Jochen Fink, Nussloch (DE); Rudolf Pfaendner, Rimbach (DE)

Correspondence Address: JoAnn Villamizar;Ciba Corporation/Patent Department, 540 White Plains Road, P.O. Box 2005, Tarrytown, NY, 10591, US

(21) Appl. No.: 11/919,604

(22) PCT Filed: Apr. 24, 2006
(86) PCT No.: PCT/EP2006/061774

§ 371 Date: Jan. 13, 2009

(30) Foreign Application Priority Data
May 3, 2005 (EP) 05103662.2

(51) Int. Cl. C08L 53/00

(52) U.S. Cl. 525/91

(57) ABSTRACT

The invention pertains to a method of producing comb block copolymers from epoxy-functionalized nitroxylethers and further monomers by anionic polymerization followed by nitroxyl mediated controlled free radical polymerization. The block copolymer backbone has defined initiating points where radical grafting of ethylenically unsaturated monomers can take place. Further aspects of the invention are comb block copolymers obtained by this process and the use of such polymers for plastic applications.

The instant invention pertains to a method of producing comb block copolymers from epoxy-functionalized nitroxylethers and further monomers by anionic polymerization followed by nitroxyl mediated controlled free radical polymerization. The block copolymer backbone has defined initiating points where radical grafting of ethylenically unsaturated monomers can take place. Further aspects of the invention are comb block copolymers obtained by this process and the use of such comb block polymers for plastic applications.

The synthesis of amphiphilic block- and graft copolymers containing both unpolar and polar chain species of different chemical nature has been approached by several techniques. A promising approach for the synthesis of aliphatic polyether backbones has been described, for example, by Heitz et al. in Macromol. Chem. 183, 1685 (1982).

One problem, especially in the design of graft copolymers, is the lack of grafting efficiency, especially if a radical “grafting to” process is chosen. Complete grafting of the graft monomer is seldom achieved and hence the final product is often contaminated with homopolymer formed in the grafting step. This process is mostly applied in the synthesis of high impact polystyrene, where styrene is grafted radically onto a polybutadiene latex. More efficient grafting is achieved when active sites within the polymeric backbone are used to covalently attach new polymer chains to the starting molecule. This requires, however, the presence of well-defined “initiation points” in the backbone.

Linear polyethers based on ethylene oxide and/or propylene oxide, besides their vast application in polyurethanes, find numerous applications in pharmaceutical and biomedical applications. Industrial applications include amongst numerous others flocculating agents in the treatment of industrial waste water, drag reduction and the modification of surface properties, such as the use as antistatic agents. Linear block copolymers of ethylene and propylene oxide also have commercial applications and serve as non-ionic tensides, emulsifiers and stability improvers (as for example “Pluronics®” manufactured by BASF). Statistical copolymers of this type are also accessible. Most of these products are liquids or waxes, depending on their final molecular weight. These copolymers are still water soluble with a minimum content of 25% ethylene oxide and hence pose an interesting class of materials for the synthesis of amphiphilic graft copolymers.

For example, WO 2004/022617 describes a method of anionically polymerizing in a first step a polymer backbone from epoxy group containing monomers wherein one monomer contains additionally a labile nitroxylether group and in a second step polymerizing under controlled free radical polymerization (CFRP) conditions a comb or star structure onto this backbone.

The present invention goes beyond this concept. It provides a method of anionically polymerizing in two steps a block copolymer backbone from epoxy group containing monomers and acrylates and in a third step polymerizing (grafting) under controlled free radical polymerization (CFRP) conditions a comb or star structure onto this back bone.

The instant process allows already introducing blocks of different polarity into the polymer backbone, thereby adapting it to different requirements. Since the grafting points are exclusively located on the polyether part of the block copolymer backbone, the length of the polyether-block determines the number of grafted side arms and the branching factor. Varying the block lengths is an additional means of adjusting the polymer properties. Furthermore composition of the monomers and overall molecular weight of the comb structure determine the polymer properties.

The resulting block-copolymer structures are of interest in surface modification applications of thermoplastic materials, insuring a permanent polar surface by anchoring the polar moiety via the less polar polymer chains in the matrix of the desired resin. Similarly, these polymers can be used as nonionic surfactants. The incorporation of the novel molecules into a backbone polymer containing epichlorohydrine can lead to rubber-thermoplastic comb copolymers. Furthermore these comb copolymers can be used as self-organizing, self assembling polymer systems, e.g. for separation processes.

One aspect of the invention is a method for the preparation of a comb block-copolymer comprising

a1) anionically polymerizing in a first step a first block of one or more epoxy group containing monomers to obtain a polyether, wherein at least one monomer is of formula (I)

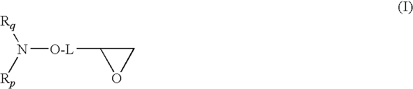

wherein L is a linking group selected from the group consisting of C₁-C₁₈alkylene, phenylene, phenylene-C₁-C₁₈alkylene, C₁-C₁₈alkylene-phenylene, C₁-C₁₈alkylene-phenylene-oxy and C₅-C₁₂cycloalkylene;

Rₚ and R_{q} are independently tertiary bound C₄-C₂₈alkyl groups which are unsubstituted or substituted by one or more electron withdrawing groups or by phenyl; or

Rₚ and R_{q} together form a 5 or 6 membered heterocyclic ring which is substituted at least by 4 C₁-C₄alkyl groups and which may be interrupted by a further nitrogen or oxygen atom;

a2) anionically polymerizing in a second step a second block wherein the monomer is a conjugated diene, styrene, substituted styrene, ketone or a compound of formula (Ia)

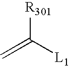

wherein R₃₀₁ is H or C₁-C₄alkyl, L₁ is CN, or —COOR₃₀₀ and R₃₀₀ is C₁-C₃₆ alkyl;
and in a third step
b) adding to the polymer obtained in the second step at least one ethylenically unsaturated monomer, heating the resulting mixture to a temperature where cleavage of the nitroxylether bond occurs and radical polymerization starts; and polymerizing to the desired degree.

The steps a1) and a2) can also be carried out inversely. In this case a compound of formula (Ia) is anionically polymerized as a first block followed by anionical polymerization of the epoxy functional monomers.

For example the monomer of formula (I) is of formula (II)

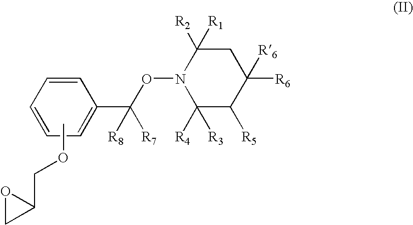

wherein
R₁, R₂, R₃ and R₄ are independently of each other C₁-C₄alkyl;
R₅ is hydrogen or C₁-C₄alkyl;
R′₆ is hydrogen and R₆ is H, OR₁₀, NR₁₀R₁₁, —O—C(O)—R₁₀ or NR₁₁—C(O)—R₁₀;
R₁₀ and R₁₁, independently are C₁-C₁₈alkyl, C₂-C₁₈alkenyl, C₂-C₁₈alkinyl or, if R₆ is NR₁₀R₁₁,
R₁₀ and R₁₁ taken together, form a C₂-C₁₂alkylene bridge or a C₂-C₁₂-alkylene bridge interrupted by at least one O atom; or
R₆ and R′₆ together are both hydrogen, a group ═O or ═N—O—R₂₀ wherein
R₂₀ is straight or branched C₁-C₁₈alkyl, C₃-C₁₈alkenyl or C₃-C₁₈alkinyl, C₅-C₁₂cycloalkyl or C₅-C₁₂cycloalkenyl, phenyl, C₇-C₉phenylalkyl or naphthyl which may be unsubstituted or substituted by one or more C₁-C₈alkyl, halogen, C₁-C₈alkoxy; —C(O)—C₁-C₃₆alkyl, or Si(Me)₃; or
R₆ and R′₆ are independently —O—C₁-C₁₂alkyl, —O—C₃-C₁₂alkenyl, —O—C₃-C₁₂alkinyl, —O—C₅-C₈cycloalkyl, —O-phenyl, —O-naphthyl, —O—C₇-C₉phenylalkyl; or
R₆ and R′₆ together form one of the bivalent groups —O—C(R₂₁)(R₂₂)—CH(R₂₃)—O—, —O—CH(R₂₁)—CH₂₂—C(R₂₂)(R₂₃)—O—, —O—CH(R₂₂)—CH₂—C(R₂₁)(R₂₃)—O—, —O—CH₂—C(R₂₁)(R₂₂)—CH(R₂₃)—O—, —O-o-phenylene-O—, —O-1,2-cyclohexyliden-O—,

### —O—CH₂—CH═CH—CH₂—O— or

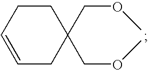

wherein
R₂₁ is hydrogen, C₁-C₁₂alkyl, COO—(C₁-C₁₂)alkyl or CH₂OR₂₄;
R₂₂ and R₂₃ are independently hydrogen, methyl or ethyl;
R₂₄ is C₁-C₁₂alkyl, benzyl or C₇-C₉phenylalkyl; and
R₇ and R₈ are independently hydrogen or C₁-C₁₈alkyl.

C₁-C₁₈alkyl can be linear or branched. Examples are methyl, ethyl, propyl, isopropyl, butyl, 2-butyl, isobutyl, t-butyl, pentyl, 2-pentyl, hexyl, heptyl, octyl, 2-ethylhexyl, t-octyl, nonyl, decyl, undecyl, dodecyl or octadecyl. Where up to C₃₋₆alkyl is possible, C₁-C₁₈alkyl is preferred.

Alkenyl having from 2 to 18 carbon atoms is a branched or unbranched radical, for example propenyl, 2-butenyl, 3-butenyl, isobutenyl, n-2,4-pentadienyl, 3-methyl-2-butenyl, n-2-octenyl, n-2-dodecenyl, isododecenyl.

Alkinyl having from 2 to 18 carbon atoms is a branched or unbranched radical, for example propinyl, 2-butinyl, 3-butinyl, isobutinyl, n-2,4-pentadiinyl, 3-methyl-2-butinyl, n-2-octinyl, n-2-dodecinyl, isododecinyl.

Examples of alkoxy are methoxy, ethoxy, propoxy, isopropoxy, butoxy, isobutoxy, pentoxy, isopentoxy, hexoxy, heptoxy or octoxy.

C₇-C₉phenylalkyl is for example benzyl, α-methylbenzyl, α,α-dimethylbenzyl or 2-phenylethyl, benzyl is preferred.

C₅-C₁₂cycloalkyl is for example cyclopentyl, cyclohexyl, cycloheptyl, methylcyclopentyl or cyclooctyl.

C₅-C₁₂cycloalkenyl is for example 3-cyclopentenyl, 3-cyclohexenyl or 3-cycloheptenyl.

Halogen is F, Cl, Br or I.

C₁-C₁₈alkylene is a branched or unbranched radical, for example methylene, ethylene, propylene, trimethylene, tetramethylene, pentamethylene, hexamethylene, heptamethylene, octamethylene, decamethylene or dodecamethylene.

C₂-C₁₂alkylene bridges interrupted by at least one O atom are, for example, —CH₂—O—CH₂—CH₂, —CH₂—O—CH₂—CH₂—CH₂, —CH₂—O—CH₂—CH₂—CH₂—CH₂—, —CH₂—O—CH₂—CH₂—O—CH₂—

Preferably R₁, R₂, R₃, R₄ are methyl, or R₁ and R₃ are ethyl and R₂ and R₄ are methyl, or R₁ and R₂ are ethyl and R₃ and R₄ are methyl.

For example R₅ is hydrogen or methyl.

In particular R′₆ is hydrogen and R₆ is H, OR₁₀, NR₁₀R₁₁, —O—C(O)—R₁₀ or NR₁₁—C(O)—R₁₀;

R₁₀ and R₁₁ independently are C₁-C₁₈alkyl, C₂-C₁₈alkenyl, C₂-C₁₈alkinyl or, if R₆ is NR₁₀R₁₁, R₁₀ and R₁₁ taken together, form a C₂-C₁₂alkylene bridge or a C₂-C₁₂-alkylene bridge interrupted by at least one O atom; or
R₆ and R′₆ together are both hydrogen, a group ═O or ═N—O—R₂₀ wherein
R₂₀ is or straight or branched C₁-C₁₈alkyl.

In another specific embodiment R₆ and R′₆ together form one of the bivalent groups —O—C(R₂₁)(R₂₂)—CH(R₂₃)—O—, —O—CH(R₂₁)—CH₂₂—C(R₂₂)(R₂₃)—O—, —O—CH(R₂₂)—CH₂—C(R₂₁)(R₂₃)—O—, —O—CH₂—C(R₂₁)(R₂₂)—CH(R₂₃)—O— and R₂₁, R₂₂ and R₂₃ have the meaning as defined above.

Specific compounds are given in Table A

TABLE A

| Compound | |
|---|---|
| Number | Structure |
| 101 | 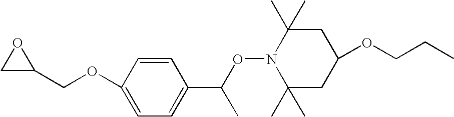 |
| 102 | 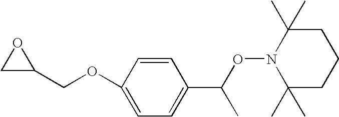 |
| 103 | 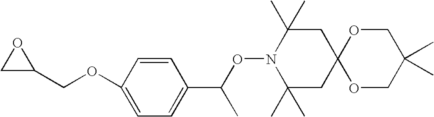 |
| 104 | 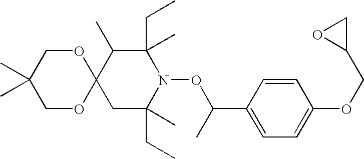 |
| 105 | 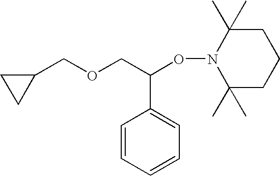 |

The compounds of formula II and in particular the compounds given in Table A are known and may be prepared as described in WO 99/46261, WO 02/48109 or U.S. Pat. No. 5,721,320.

Examples of suitable other epoxy functional monomers

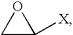

which can be used as comonomers are given in Table B.

TABLE B

| Name | CAS No. | X |
|---|---|---|
| Ethylene oxide | 75-21-8 | H |
| Propylene oxide | 75-56-9 | CH₃ |
| 2,3-Epoxypropyl- | 122-60-1 | CH₂—O—C₆H₅ |
| phenylether | | |
| 2,3-Epoxypropyl-4- | 6178-32-1 | CH₂—O—C₆H₅—C₉H₁₉ |
| nonyl-phenylether | | |
| Epichlorohydrine | 106-89-8 | —CH₂—Cl |
| 2,3-Epoxypropyl- | 19932-27-5 | CH₂—O—CH₂—(CF₂)₃CHF₂ |
| 2,2,3,3,4,4,5,5- | | |
| octafluoropentylether | | |

For instance the epoxy group containing monomer, different from formula I is selected from the group consisting of ethylene oxide, propylene oxide, 2,3-epoxypropyl-phenylether, 2,3-epoxypropyl-4-nonyl-phenylether, epichlorohydrine and 2,3-epoxypropyl-2,2,3,3,4,4,5,5-octafluoropentylether.

These compounds are known and commercially available.

For example the molar ratio of the monomer of formula I to the sum of the other monomers is from 100:0 to 1:99, particularly 80:20 to 20:80, specifically 75:25 to 25:75.

Suitable monomers for step a2), which can be anionically polymerized are conjugated dienes, such as butadiene, styrenes, substituted styrenes and ketones, such as lactames, lactones, oxiranes or a compound of formula (Ia)

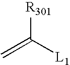

R₃₀₁ is H or C₁-C₄alkyl, L₁ is —CN or —COOR₃₀₀ and R₃₀₀ is C₁-C₃₆ alkyl.

In particular R₃₀₁ is H and L₁ is —CN or —COOR₃₀₀ wherein R₃₀₀ is C₁-C₈alkyl.

The general polymerization procedure of step a) is well known and for example described in Encyclopedia of Polymer Science and Technology, Vol 6, 1967, 103-209.

There are principally two different processes. The first depends upon the tendency of the oxiran group to oxyalkylated active-hydrogen sites in the presence of Lewis acids or Lewis bases as catalysts. The second type of polymerization reaction involves the rapid polymerization of the oxiran group to high molecular weight polymers on a catalytic surface in a heterogeneous reaction system. Other initiation systems are described in Odian, “Principles of polymerization”, Wiley-Interscience New York, 1991, pp. 536 and Houben Weyl, Makromolekulare Stoffe, Bd. E20/2, Thieme Stuttgart, 1987, pp 1367. They include furthermore aluminium porphyrin compounds and certain iron and zinc complexes as catalysts.

The polymerization can be carried out in bulk or in solution, containing 10-90% (by vol.) solvent, the latter especially if gaseous monomers (propylene oxide or ethylene oxide) are used. Suitable solvents include tetrahydrofurane (THF), cyclohexane, toluene, dimethylformamide (DMF), chlorinated solvents and mixtures thereof.

Suitable Lewis bases are for example alkali metal alcoholates.

The block copolymer of step a) has for example an average weight molecular weight of M_{w} 1000 to 100 000, preferably from 1500 to 50 000.

The reaction temperature should be kept preferably as low as possible since cleavage of the nitroxylether bond depends on its chemical structure and may occur at temperatures above 100° C. The polymerization temperature should therefore not exceed 100° C. A suitable polymerization temperature is for example from −80° to 80° C., for instance from −20 to 70° C. and preferably from 0° to 60° C. Polymerization is normally carried out under inert gas atmosphere at normal atmospheric pressure.

Since lower reaction temperatures are applied reaction time is usually longer, typically from 1-72 hours, in particular 1-48 hours, preferably 2-24 hours.

The isolation of the polyether backbone polymer depends on its molecular structure. Residual monomer can be removed in vacuo at temperatures not exceeding 100° C. if they are liquid, extracted (for example via Soxleth extraction) or washed with appropriate solvents if they are solid.

Preferably in step b) the ethylenically unsaturated monomer or oligomer is selected from the group consisting of styrene, substituted styrene, conjugated dienes, (alkyl)acrylic esters, (meth)acrylonitriles and (alkyl)acrylamides.

In particular in step b) the ethylenically unsaturated monomers are styrene, methylacrylate, ethylacrylate, butylacrylate, isobutylacrylate, tert. butylacrylate, methyl(meth)acrylate, ethyl(meth)acrylate, butyl(meth)acrylate, acrylonitrile.

Particularly the ethylenically unsaturated monomers are isoprene, 1,3-butadiene, α-C₅-C₁₈alkene, styrene, α-methyl styrene, p-methyl styrene or a compound of formula CH₂═C(Rₐ)—(C=Z)-R_{b}, wherein Rₐ is hydrogen or C₁-C₄alkyl, R_{b} is NH₂, O⁻(Me⁺), glycidyl, unsubstituted C₁-C₁₈alkoxy, C₂-C₁₀alkoxy interrupted by at least one N and/or O atom, or hydroxy-substituted C₁-C₁₈alkoxy, unsubstituted C₁-C₁₈alkylamino, di(C₁-C₁₈alkyl)amino, hydroxy-substituted C₁-C₁₈alkylamino or hydroxy-substituted di(C₁-C₁₈alkyl)amino, —O—CH₂—CH₂—N(CH₃)₂ or —O—CH₂—CH₂—N⁺H(CH₃)₂ An⁻;

An⁻ is a anion of a monovalent organic or inorganic acid;
Me is a monovalent metal atom or the ammonium ion.
Z is oxygen or sulfur.

Examples for Rₐ as C₂-C₁₀alkoxy interrupted by at least one O atom are of formula

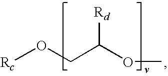

wherein R_{c} is C₁-C₂₅alkyl, phenyl or phenyl substituted by C₁-C₁₈alkyl, R_{d} is hydrogen or methyl and v is a number from 1 to 50. These monomers are for example derived from non ionic surfactants by acrylation of the corresponding alkoxylated alcohols or phenols. The repeating units may be derived from ethylene oxide, propylene oxide or mixtures of both.

Further examples of suitable acrylate or methacrylate monomers, which can be used in step b) are given below.

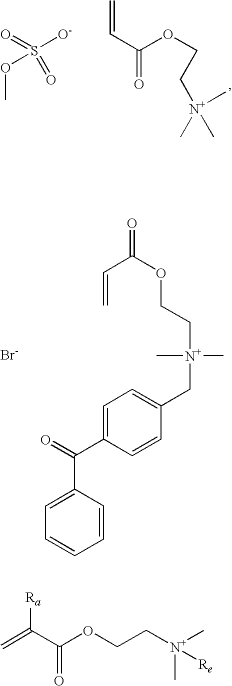

### An⁻ or

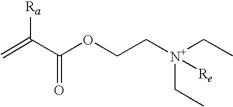

An⁻, wherein An⁻ and Rₐ have the meaning as defined above and Rₑ is methyl, benzyl or benzoylbenzyl. An⁻ is preferably Cl⁻, Br⁻ or ⁻O₃S—O—CH₃.

Further acrylate monomers are

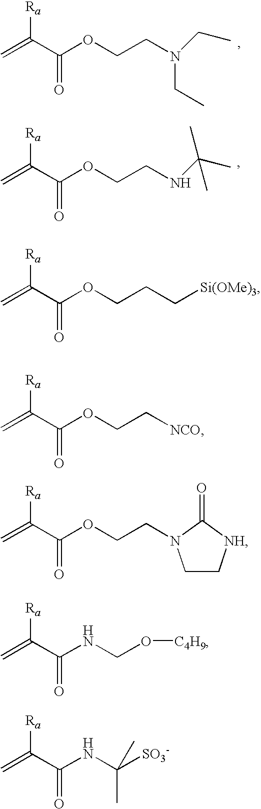

Me⁺, Me⁺ is an akali metal cation or the ammonium cation.

Examples for suitable monomers other than acrylates are

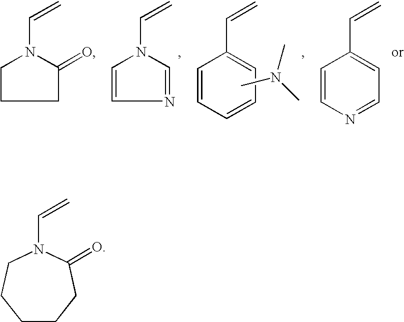

Preferably Rₐ is hydrogen or methyl, R_{b} is NH₂, gycidyl, unsubstituted or with hydroxy substituted C₁-C₄alkoxy, unsubstituted C₁-C₄alkylamino, di(C₁-C₄alkyl)amino, hydroxy-substituted C₁-C₄alkylamino or hydroxy-substituted di(C₁-C₄alkyl)amino; and

Z is oxygen.

For example in step b) the weight ratio between the block copolymer prepared in step a1) and a2) and the ethylenically unsaturated monomer added in step b) is from 90:10 to 10:90.

As already mentioned the nitroxylether bond cleaves at elevated temperature and radical polymerization is initiated. Preferably in step b) the polymerization temperature is from 80° C. to 160° C., in particular from 100° C. to 140° C.

Typically the average weight molecular weight M_{w} is from 2000 to 300 000, preferably from 3000 bis 100 000.

The polydispersity index of the resulting comb copolymer is typically between 1.1 and 3.0.

Another aspect of the invention is a block copolymer obtainable according to step a1) and a2) of the method as described above.

The copolymer backbone has, for example, an idealized structure as given below.

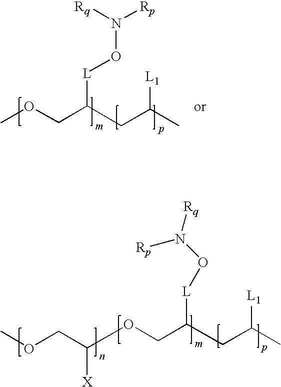

The meaning of L, Rₚ, R_{q}, L₁ and X are as given above. m, n and p are independently a number from 3 to 1000, preferably 5 to 500.

A further aspect of the invention is a comb block copolymer obtainable according to the method as defined above in steps a1), a2) and b).

Yet a further aspect of the invention is the use of a comb block copolymer obtainable according to the method as defined above in steps a1), a2) and b) as adhesive, surface modifier, surfactant or compatibilizer in thermoplastic, elastic or thermosetting polymers or as plastic material for extrusion or injection molding for shaping parts.

Definitions for the individual substituents have already been given for the method of preparation of comb block copolymers, they apply also to the other aspects of the invention.

The polymers prepared by the present invention are useful for following applications: forming parts, extrusion or injection moldings, plastic materials for shaping parts with for example improved processability and/or barrier properties, adhesives, detergents, dispersants, emulsifiers, surfactants, defoamers, adhesion promoters, corrosion inhibitors, viscosity improvers, lubricants, rheology modifiers, thickeners, crosslinkers, paper treatment, water treatment, electronic materials, paints, coatings, photography, ink materials, imaging materials, superabsorbants, cosmetics, hair products, preservatives, biocide materials or modifiers for asphalt, leather, textiles, ceramics and wood. Furthermore these comb copolymers can be used as self-organizing, self assembling polymer systems, e.g. for separation processes.

Both step a) and step b) are living or “quasi living” polymerizations Step a) is an anionic living polymerization and step b) a living radical polymerization.

Since the polymerization of step b) is a living radical polymerization, it can be started and stopped practically at will. Furthermore, the polymer product retains the functional alkoxyamine group allowing a continuation of the polymerization in a living matter. Thus, in one embodiment of this invention, once the first monomer is consumed in the initial radical polymerizing step a second monomer can then be added to form a second block on the growing polymer chain in a second polymerization step. Therefore it is possible to carry out additional polymerizations with the same or different monomer(s) to prepare multi-block copolymers in the comb structure.

Furthermore, since this is a living radical polymerization, blocks can be prepared in essentially any order. One is not necessarily restricted to preparing block copolymers where the sequential polymerizing steps must flow from the least stabilized polymer intermediate to the most stabilized polymer intermediate, such as is the case in ionic polymerization. Thus it is possible to prepare a multi-block copolymer in which a polyacrylonitrile or a poly(meth)-acrylate block is prepared first, then a styrene or butadiene block is attached thereto, and so on.

Random copolymers and tapered copolymer structures can be synthesized as well by using a mixture of monomers or adding a second monomer before the first one is completely consumed.

The following examples illustrate the invention.

### General Remarks:

Solvents and monomers are distilled over a Vigreux column under argon atmosphere or under vacuum, shortly before being used.

To remove oxygen all polymerization reaction mixtures are flushed before polymerization with argon and evacuated under vacuum applying a freeze-thaw cycle. The reaction mixtures are then polymerized under argon atmosphere.

At the start of the polymerization reaction, all starting materials are homogeneously dissolved.

Conversion is determined by removing unreacted monomers from the polymer by precipitation in methanol and/or by drying in vacuo (0.002 torr) at least 60 minutes, weighing the remaining polymer and subtracting the weight of the initiator.

Characterization of the polymers is carried out by GPC (Gel Permeation Chromatography).

GPC: Is performed using RHEOS 4000 of FLUX INSTRUMENTS. Tetrahydrofurane (THF) is used as a solvent and is pumped at 1 ml/min. Two chromatography columns are put in series: type PIgel 5 μm mixed-C of POLYMER INSTRUMENTS, Shropshire, UK. Measurements are performed at 40° C. The columns are calibrated with low polydispersity polystyrenes having Mn from 200 to 2 000 000 Dalton. Detection is carried out using a RI-Detector ERC-7515A of ERCATECH AG at 30° C.

### 1. Synthesis of a Blockcopolymer Backbone (Polyether-b-PMMA)

The epoy-functional nitroxylether used is:

### Compound 103

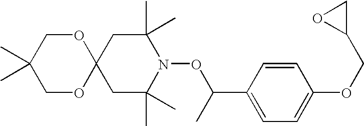

Compound 103 is prepared as described in WO 02/48109.

### EXAMPLE E1+E2

In a dry, Argon-purged Schlenk tube equipped with a rubber septum, a magnetic stir bar and an Argon inlet, 0.505 g (0.0045 mol) potassium-tert.-butylate is dissolved in 10 ml dry toluene. 8.67 g (0.02 mol) compound 103 is dissolved in 30 ml dry toluene and added to the initiator solution. The solution is heated at 60° C. for 6 h (Note: if a NOR is present, the polymerization temperature must not exceed 11° C. in order to avoid NOR decomposition). After cooling down at room temperature a 5 ml sample is taken (E1). Then a solution of 11.21 g (0.108 mol) methylmethacrylate in 40 ml dry toluene is added dropwise and the mixture is stirred over night at room temperature. The reaction is stopped with 5 ml methanol and solvents are removed in vacuo. The polymer is precipitated in methanol and dried overnight in vacuo at 60° C. until constant weight.

The blockcopolymer (E2) is obtained as white solid.

| Example | Conv. [%] | Mn | Mw | Mw/Mn | |
|---|---|---|---|---|---|
| E1 | 99 | 1600 | 1900 | 1.2 | polyether backbone |
| E2 | 25 | 7400 | 10800 | 1.5 | blockcopolymer |
| | | | | | backbone |

2. Comb copolymer formation, “grafting from” step

### EXAMPLE E3

In a Büchi miniautoclave equipped with a magnetic stir bar and an Argon-Inlet, 2.5 g of E2 are dissolved in a mixture of 32.25 g styrene/acrylonitrile (ratio 3:1). The solution is degassed by cooling down in an ice bath and then purged with Argon. The autoclave is then immersed in an oil bath and heated at 110° C. for 6 hours. After cooling to room temperature, the solution is precipitated in methanol and dried at 30° C. in vacuo until constant weight. The reaction product is analyzed by GPC and the comb copolymer yield (=amount of styrene/acrylonitrile monomer grafted from the blockcopolymer backbone) is determined gravimetrically.

The comb copolymer (E3) is obtained as white solid.

| | % styrene/acrylonitrile | | | |
|---|---|---|---|---|
| Example | grafted from backbone | Mn | Mw | Mw/Mn |
| E3 | 48 | 65000 | 150000 | 2.3 |

1. Method for the preparation of a comb block-copolymer comprising
a1) anionically polymerizing in a first step a first block of one or more epoxy group containing monomers to obtain a polyether, wherein at least one monomer is of formula (I) 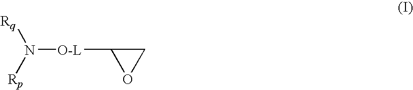
wherein L is a linking group selected from the group consisting of C₁-C₁₈alkylene, phenylene, phenylene-C₁-C₁₈alkylene, C₁-C₁₈alkylene-phenylene, C₁-C₁₈alkylene-phenylene-oxy and C₅-C₁₂cycloalkylene;
Rₚ and R_{q} are independently tertiary bound C₄-C₂₈alkyl groups which are unsubstituted or substituted by one or more electron withdrawing groups or by phenyl; or
Rₚ and R_{q} together form a 5 or 6 membered heterocyclic ring which is substituted at least by 4 C₁-C₄alkyl groups and which may be interrupted by a further nitrogen or oxygen atom;
a2) anionically polymerizing in a second step a second block wherein the monomer is a conjugated diene, styrene, substituted styrene, ketone or a compound of formula (Ia) 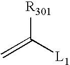
wherein R₃₀₁ is H or C₁-C₄alkyl, L₁ is CN or —COOR₃₀₀ and R₃₀₀ is C₁-C₃₆ alkyl;
and in a third step
b) adding to the polymer obtained in the second step at least one ethylenically unsaturated monomer, heating the resulting mixture to a temperature where cleavage of the nitroxylether bond occurs and radical polymerization starts;
and polymerizing to the desired degree.

2. A method according to claim 1 wherein the steps a1) and a2) are carried out inversely.

3. A method according to claim 1 wherein the monomer of formula (I) is of formula (II) 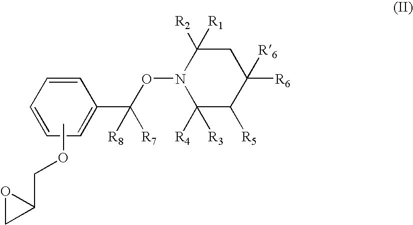
wherein
R₁, R₂, R₃ and R₄ are independently of each other C₁-C₄alkyl;
R₅ is hydrogen or C₁-C₄alkyl;
R′₆ is hydrogen and R₆ is H, OR₁₀, NR₁₀R₁₁, —O—C(O)—R₁₀ or NR₁₁—C(O)—R₁₀;
R₁₀ and R₁₁ independently are C₁-C₁₈alkyl, C₂-C₁₈alkenyl C₂-C₁₈alkinyl or, if R₆ is NR₁₀R₁₁, R₁₀ and
R₁₁ taken together form a C₂-C₁₂alkylene bridge or a C₂-C₁₂-alkylene bridge interrupted by at least one O atom; or
R₆ and R′₆ together are both hydrogen, a group ═O or ═N—O—R₂₀ wherein
R₂₀ is straight or branched C₁-C₁₈alkyl, C₃-C₁₈alkenyl or C₃-C₁₈alkinyl, C₅-C₁₂cycloalkyl or
C₅-C₁₂cycloalkenyl, phenyl, C₇-C₉phenylalkyl or naphthyl which may be unsubstituted or substituted by one or more C₁-C₈alkyl, halogen, C₁-C₈alkoxy; —C(O)—C₁-C₃₆alkyl or Si(Me)₃; or
R₆ and R′₆ are independently —O—C₁-C₁₂alkyl, —O—C₃-C₁₂alkenyl, —O—C₃-C₁₂alkinyl, —O—C₅-C₈cycloalkyl, —O-phenyl, —O-naphthyl or —O—C₇-C₉phenylalkyl; or
R₆ and R′₆ together form one of the bivalent groups —O—C(R₂₁)(R₂₂)—CH(R₂₃)—O—, —O—CH(R₂₁)—CH₂₂—C(R₂₂)(R₂₃)—O—, —O—CH(R₂₂)—CH₂—C(R₂₁)(R₂₃)—O—, —O—CH₂—C(R₂₁)(R₂₂)—CH(R₂₃)—O—, —O-o-phenylene-O—, —O-1,2-cyclohexyliden-O—, —O—CH₂—CH═CH—CH₂—O— or 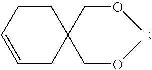
wherein
R₂₁ is hydrogen, C₁-C₁₂alkyl, COO—(C₁-C₁₂)alkyl or CH₂OR₂₄;
R₂₂ and R₂₃ are independently hydrogen, methyl or ethyl;
R₂₄ is C₁-C₁₂alkyl, benzyl or C₇-C₉phenylalkyl; and
R₇ and R₈ are independently hydrogen or C₁-C₁₈alkyl.

4. A method according to claim 3 wherein R₁, R₂, R₃ and R₄ are methyl or R₁ and R₃ are ethyl and R₂ and R₄ are methyl or R₁ and R₂ are ethyl and R₃ and R₄ are methyl.

5. A method according to claim 3 wherein R₅ is hydrogen or methyl.

6. A method according to claim 3 wherein
R′₆ is hydrogen and R₆ is H, OR₁₀, NR₁₀, OR₁₁, —O—C(O)—R₁₀ or NR₁₁—C(O)—R₁₀;
R₁₀ and R₁₁ independently are C₁-C₁₈alkyl, C₂-C₁₈alkenyl or C₂-C₁₈alkinyl or, if R₆ is NR₁₀R₁₁, R₁₀ and R₁₁ taken together form a C₂-C₁₂alkylene bridge or a C₂-C₁₂-alkylene bridge interrupted by at least one O atom; or
R₆ and R′₆ together are both hydrogen or a group ═O or ═N—O—R₂₀ wherein
R₂₀ is or straight or branched C₁-C₁₈alkyl.

7. A method according to claim 3 wherein
R₆ and R′₆ together form one of the bivalent groups —O—C(R₂₁)(R₂₂)—CH(R₂₃)—O—, —O—CH(R₂₁)—CH₂₂—C(R₂₂)(R₂₃)—O—, —O—CH(R₂₂)—CH₂—C(R₂₁)(R₂₃)—O— or —O—CH₂—C(R₂₁)(R₂₂)—CH(R₂₃)—O—.

8. A method according to claim 1 wherein the epoxy group containing monomer different from formula I is selected from the group consisting of ethylene oxide, propylene oxide, 2,3-epoxypropyl-phenylether, 2,3-epoxypropyl-4-nonyl-phenylether, epichlorohydrine and 2,3-epoxypropyl-2,2,3,3,4,4,5,5-octafluoropentylether.

9. A method according to claim 1 wherein in step a) the molar ratio of the monomer of formula I to the sum of the other monomers is from 100:0 to 1:99.

10. A method according to claim 1 wherein the monomer of step a2) is selected from the group consisting of butadiene, styrenes, substituted styrenes, ketones and a compound of formula (Ia) 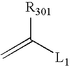
wherein R₃₀₁ is H or C₁-C₄alkyl, L₁ is —CN or —COOR₃₀₀ and R₃₀₀ is C₁-C₃₆ alkyl.

11. A method according to claim 1 wherein in step b) the ethylenically unsaturated monomer or oligomer is selected from the group consisting of styrene, substituted styrene, conjugated dienes, (alkyl)acrylic esters, (meth)acrylonitriles and (alkyl)acrylamides.

12. A method according to claim 11 wherein in step b) the ethylenically unsaturated monomers are styrene, methylacrylate, ethylacrylate, butylacrylate, isobutylacrylate, tert-butylacrylate, methyl(meth)acrylate, ethyl(meth)acrylate, butyl(meth)acrylate or acrylonitrile.

13. A method according to claim 1 wherein in step b) the weight ratio between the block copolymer prepared in step a1) and a2) and the ethylenically unsaturated monomer added in step b) is from 90:10 to 10:90.

14. A method according to claim 1 wherein in step b) the polymerization temperature is from 80° C. to 160° C.

15. A block copolymer obtained according to step a1) and a2) of the method of claim 1.

16. A comb block copolymer obtained according to the method of claim 1.

17. (canceled)
